(19) United States
(12) Patent Application Publication
(10) Pub. No.: US 2016/0324355 A1
(43) Pub. Date: Nov. 10, 2016

(54) DEVICE AND METHOD OF USE FOR AN ILLUMINATED CROSS

(71) Applicant: Lucio Frederico Garcia, Austin, TX (US)

(72) Inventor: Lucio Frederico Garcia, Austin, TX (US)

(21) Appl. No.: 15/149,165

(22) Filed: May 8, 2016

Related U.S. Application Data
(60) Provisional application No. 62/158,859, filed on May 8, 2015.

(51) Int. Cl. A47G 33/02; F21V 15/015

(52) U.S. Cl. CPC A47G 33/02; F21V 15/015; F21W 2121/00

(57) ABSTRACT

Disclosed herein are devices and methods of use directed to cross decorative markers. More specifically, the present invention relates to illuminated crosses for commemorative and decorative purpose having uniform illumination throughout the cross from within the structure. In embodiments, the disclosed device is comprised of a hollow translucent or transparent cruciform housing component and a light source cruciform component positioned internal to the hollow translucent or transparent cruciform housing component and having lights running along the front, the back, and the end portions of the light source cruciform component. In embodiments, the lights are positioned along the entire horizontal and vertical lengths of the light source cruciform component. In another embodiment, the device is further comprised of end cap components to further aid the directional distribution of the emitting light from the end portions of the device. In yet other embodiments, the illuminated cross device is further comprised of a mounting or attachment component.

### CROSS-REFERENCE TO RELATED APPLICATIONS

This application claims the benefit under Title 35 United States Code §119(e) of U.S. Provisional Patent Application Ser. No.: 62/158,859; Filed: May 8, 2015, the full disclosure of which is incorporated herein by reference.

### STATEMENT REGARDING FEDERALLY SPONSORED RESEARCH OR DEVELOPMENT

Not applicable

### THE NAMES OF THE PARTIES TO A JOINT RESEARCH AGREEMENT

Not applicable

### INCORPORATING-BY-REFERENCE OF MATERIAL SUBMITTED ON A COMPACT DISC

Not applicable

### SEQUENCE LISTING

Not applicable

### FIELD OF THE INVENTION

The present invention relates generally to the field of decorative markers. More specifically, the present invention relates to an illuminated cross for commemorative and decorative purposes.

### BACKGROUND OF THE INVENTION

Without limiting the scope of the disclosed devices and methods, the background is described in connection with novel illuminated crosses.

The field's prior art reflects many approaches and designs for illuminated crosses. There are many different designs and uses for illuminated crosses such as for a graveyard, memorial service, religions decorations and the like. Many well-known and available illuminated crosses may have a single or multiple lights on the structure to light the cross. However, with these designs and devices, the distribution and the arrangement of the emitted lights fail to illuminate the cross structure at satisfactory levels. The brightness and uniformity of the illumination is not adequate. Additionally, accessing and changing these lights pose some difficulty.

A first example of an illuminated cross in the prior art is described in U.S. Pat. No. 4,453,201 issued on Jun. 5, 1984 to Lee W. Proutry. In this example, the device is comprised of a frame constructed in the form cross that uses lights positioned at the end of the horizontal and vertical plates facing inward as well as convex reflectors located near the intersection of the plates. This allows the prior art to distribute the light more evenly in smaller constructed crosses. As the size of the cross becomes larger, the prior art does not account for the loss of light between the light and the reflector resulting in a diminished illuminated effect in larger structures. Additionally, this prior art does not allow for illumination of the end caps of the cross.

A second example of an illuminated cross in the prior art is described in U.S. patent application Ser. No. 2010/0085743 published on Apr. 8, 2010 and filed by Steven M. Franklin. In this example, the device is comprised of a frame constructed in the form of a cross that uses at least four lights to provide illumination for the structure. The lights are positioned throughout the structure having one light in each of the four arms of the cross in an attempt to provide illumination to the whole structure. By using multiple lights, this prior art can adapt to larger structures but this approach does not provide a uniformly illuminated structure. An additionally, this prior art faces the lights towards the front of the cross thus failing to vividly illuminate the back or the end caps.

While all of the aforementioned approaches and designs may fulfill their unique purposes, none of them fulfill the needs for a practical, efficient, and effective means for providing an illuminated cross which provides thorough illumination for various size crosses.

In view of the foregoing, it is apparent that there exists a need in the art for an illuminated cross which overcomes, mitigates, or solves the above problems in the art. It is the purpose of this invention to fulfill this and other needs in the art, which will become apparent to the skilled artisan once given the following disclosure.

### BRIEF SUMMARY OF THE INVENTION

The present invention, therefore, provides for devices and methods of use directed to illuminated crosses for decorative and commemorative purposes having uniform illumination throughout the cross from within the structure.

In embodiments, the disclosed device is comprised of a hollow translucent or transparent cruciform housing component or just referred to as the hollow cruciform housing component and a light source cruciform component positioned internal to the hollow translucent or transparent cruciform housing component and having lights running along the front, the back, and the end portions of the light source cruciform component.

The hollow cruciform housing component in embodiments has a combination of translucent and non-translucent portions. In other embodiments, the hollow cruciform housing component has a combination of transparent and non-transparent portions. In yet other embodiments, the hollow cruciform housing component is a combination of translucent, transparent, and non-translucent non-transparent portions.

The light source cruciform component is embodiments, has the lights positioned along the entire horizontal and vertical lengths of the light source cruciform component on the front side portion. In embodiments, the lights are positioned along the entire horizontal and vertical lengths of the light source cruciform component on the front side portion as well as the back side portion. In embodiments, the lights are also positioned on the end portions of the light source cruciform component.

In another embodiment, the device is further comprised of end cap components to further aid the directional distribution of the emitting light from the end portions of the device.

In yet other embodiments, the illuminated cross device is further comprised of a mounting or attachment component. These may be for example and not a limitation a base mount, Velcro, and hanging clips/hooks to mount to the wall or hang from the ceiling.

In summary, the present invention discloses devices and methods directed to decorative markers. More specifically, the present invention relates to an illuminated cross for commemorative and decorative purpose having uniform illumination throughout the cross from within the structure.

### BRIEF DESCRIPTION OF THE SEVERAL VIEWS OF THE DRAWINGS

For a more complete understanding of the features and advantages of the present invention, reference is now made to the detailed description of the invention along with the accompanying figures in which:

FIG. 1 is a front perspective view of the illuminated cross device in accordance with embodiments of the disclosure;

FIG. 2 is an exploded view of the illuminated cross device in accordance with embodiments of the disclosure;

FIG. 3 is a front view of the illuminated cross device in accordance with embodiments of the disclosure;

FIG. 4 is a back view of the illuminated cross device in accordance with embodiments of the disclosure;

FIG. 5 is a left side view of the illuminated cross device in accordance with embodiments of the disclosure;

FIG. 6 is a right side view of the illuminated cross device in accordance with embodiments of the disclosure;

FIG. 7 is a top view of the illuminated cross device in accordance with embodiments of the disclosure;

FIG. 8 is a bottom view of the illuminated cross device in accordance with embodiments of the disclosure; and

FIG. 9 is an environment view of the illuminated cross device mounted on a wall in accordance with embodiments of the disclosure.

### DETAILED DESCRIPTION OF THE INVENTION

Disclosed herein is a device and methods of use directed to illuminated crosses. The numerous innovative teachings of the present invention will be described with particular reference to several embodiments (by way of example, and not of limitation).

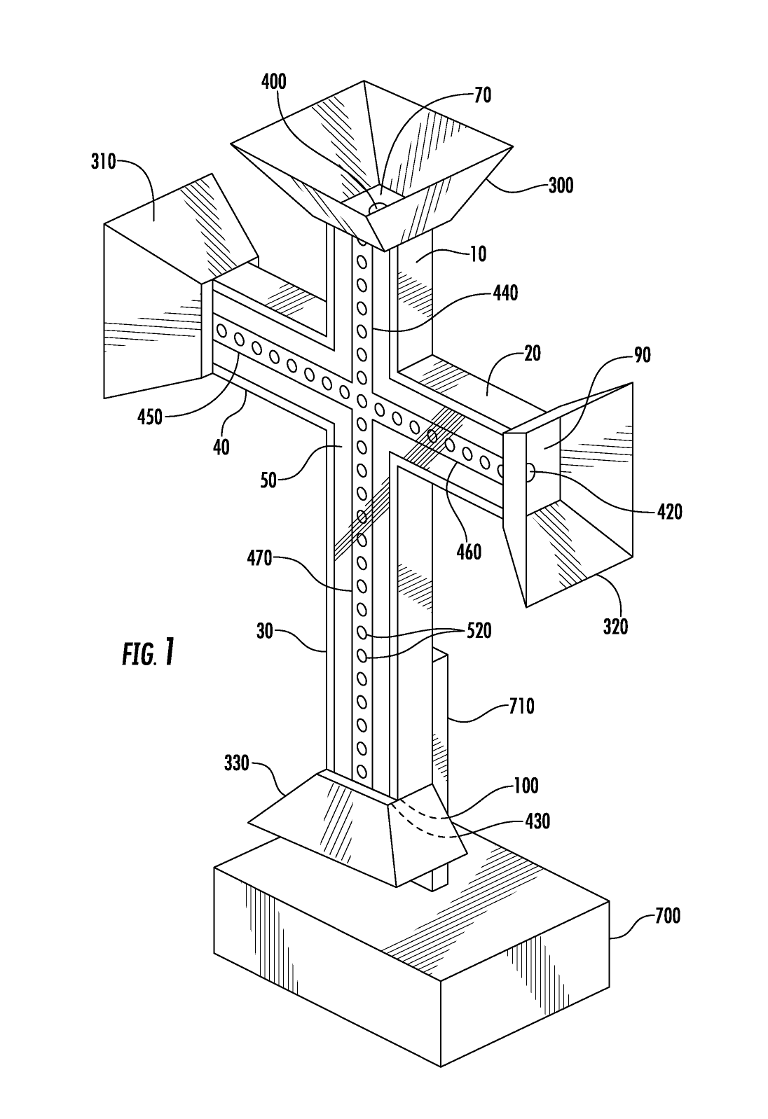

Reference is first made to FIG. 1, a front perspective view of the illuminated cross device in accordance with embodiments of the disclosure. This illustration provides an overall layout of the device, which may be made out of as an example and not a limitation, wood, polymers, glass, metal, foam, and rubber.

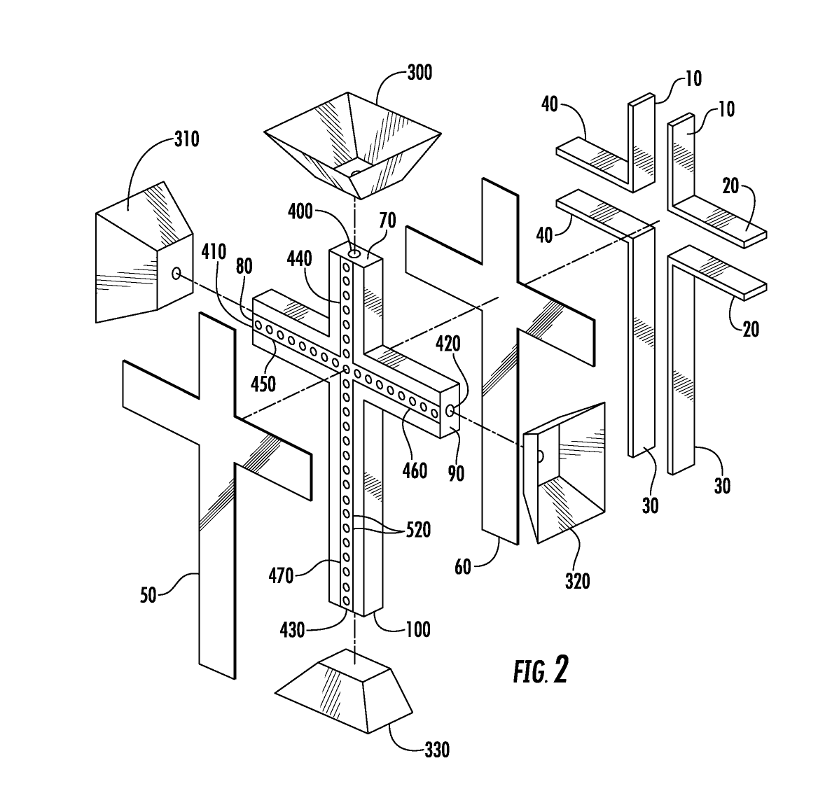

Reference is now made to FIG. 2, an exploded view of the illuminated cross device in accordance with embodiments of the disclosure. In embodiments, the disclosed device is comprised of a hollow translucent or transparent cruciform housing component or just referred to as the hollow cruciform housing component and a light source cruciform component positioned internal of the hollow cruciform housing component. This hollow cruciform housing component is made up of two upper half portions 10, 20, 40, two lower half portions 20, 30, 40, a front side portion 50, and a back side portion 60. The upper half 10, 20, 40 and lower half portions 20, 30, 40 may be rounded in some embodiments. The two upper half portions 10, 20, 40 form the sides of the upper portion 10 of the hollow cruciform component. The two lower half portions 20, 30, 40 form the sides of the lower portion 30 of the hollow cruciform component. A combination of an upper half portion 10, 40 in conjunction with a lower half portion 30, 40 forms the sides of the left side portion 40 of the hollow cruciform component. A combination of an upper half portion 10, 20 in conjunction with a lower half portion 20, 30 forms the sides of the right side portion 20 of the hollow cruciform component. The front side portion 50 is positioned on the front side of the two upper half portions 10, 20, 40 and the two lower half portions 20, 30, 40 with the back side portion 60 positioned on the back side of the two upper half portions 10, 20, 40 and the two lower half portions 20, 30, 40.

The hollow cruciform housing component in embodiments has a combination of translucent 50, 60 and non-translucent portions 10, 20, 30, 40 or the entire structure may be translucent 10, 20, 30, 40, 50, 60. In other embodiments, the hollow cruciform housing component has a combination of transparent 50, 60 and non-transparent portions 10, 20, 30, 40 or the entire structure may be transparent 10, 20, 30, 40, 50, 60. In yet other embodiments, the hollow cruciform housing component is a combination of translucent, transparent, and non-translucent non-transparent portions. Various combinations of the portions' materials may be changed to allow customized illuminations to be achieved.

The light source cruciform component allows the mounting and positioning of the lights 520 within the device and also houses a power source for the lights such as but not limited to batteries or a power plug. The light source cruciform component in embodiments has lights 520 running along the front portion in the horizontal direction 450, 460 and in the vertical direction 440, 470. In embodiments, the lights 520 do not run the full length in the horizontal 450, 460 and vertical directions 440, 470 of the light source cruciform component. In other embodiments, the lights 520 do run the full length in the horizontal 450, 460 and vertical directions 440, 470 of the light source cruciform component. In other embodiments, lights 400, 410, 420, 430 are placed on the end portions 70, 80, 90, 100 of the light source cruciform component.

In another embodiment, the device is further comprised of end cap components 300, 310, 320, 330 to further aid the directional distribution of the emitting light from the end portions of the device. The end cap components 300, 310, 320, 330 may be attached directly to the end portions 70, 80, 90, 100 of the light source cruciform component. On the end cap portion that attaches to the end portions 70, 80, 90, 100 of the light source cruciform component, an opening is configured to allow the lights 400, 410, 420, 430 on the end portions 70, 80, 90, 100 of the light source cruciform component to pass through. The hollow cruciform housing component in embodiments may be mounted or attached to the end cap components 300, 310, 320, 330 allowing the light source crucifix component to reside or be positioned inside the formed cavity of the hollow crucifix component.

In embodiments, the hollow cruciform housing component's front side portion 50 is attached or flush with the front side portion 440, 450, 460, 470 of the light source cruciform component. In another embodiment, the hollow cruciform housing component's front side portion 50 is spaced away at a distance in the horizontal direction from the front side portion 440, 450, 460, 470 of the light source cruciform component. That is the hollow cruciform housing component's front side portion 50 does not touch the front side portion 440, 450, 460, 470 of the light source cruciform component forming a cavity.

In embodiments, the hollow cruciform housing component's back side portion 60 is attached or flush with the back side portion 480, 490, 500, 510 of the light source cruciform component. In another embodiment, the hollow cruciform housing component's back side portion 60 is spaced away at a distance in the horizontal direction from the back side portion 480, 490, 500, 510 of the light source cruciform component. That is the hollow cruciform housing component's back side portion 60 does not touch the back side portion 480, 490, 500, 510 of the light source cruciform component forming a cavity.

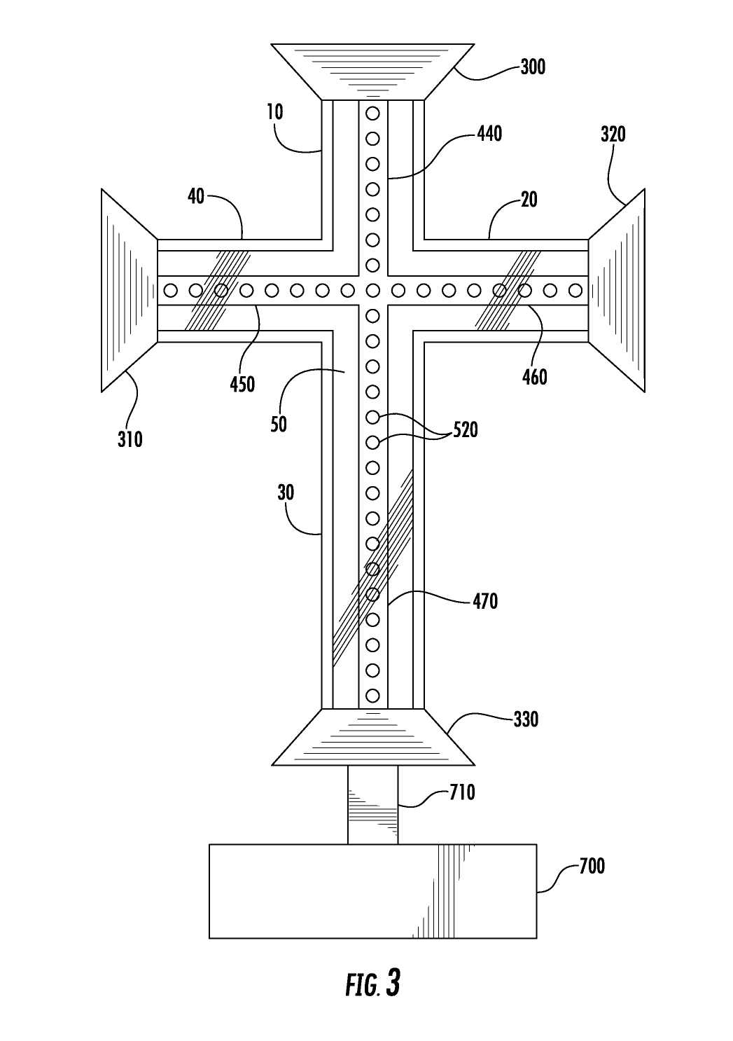

Reference is next made to FIG. 3, a front view of the illuminated cross device in accordance with embodiments of the disclosure. In embodiments, the illuminated cross device is further comprised of a mounting or attachment component. These may be for example and not a limitation a base mount, Velcro, and hanging clips/hooks to mount to the wall or hang from the ceiling. In this illustration is shown a base 700 and attachment arm 710. The attachment arm is attached to the illuminated cross device and the base 700. The base is made of a rigid material, such as but not limited to metals, polymers, and stones, which allows the illuminated cross device to be positioned upright and not fall over.

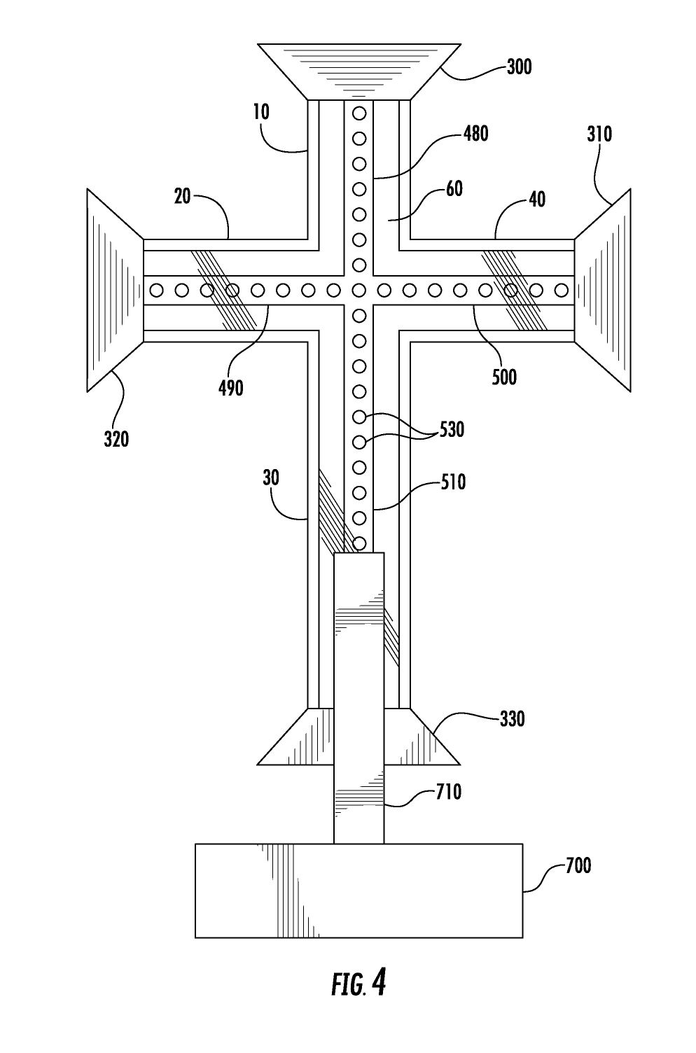

Reference is now made to FIG. 4, a back view of the illuminated cross device in accordance with embodiments of the disclosure. In embodiments light source cruciform component has lights 520 running along the back portion in the horizontal direction 490, 500 and in the vertical direction 480, 510. In embodiments, the lights 520 do not run the full length in the horizontal 490, 500 and vertical directions 480, 510 of the light source cruciform component. In other embodiments, the lights 520 run the full length in the horizontal 490, 500 and vertical directions 480, 510 of the light source cruciform component.

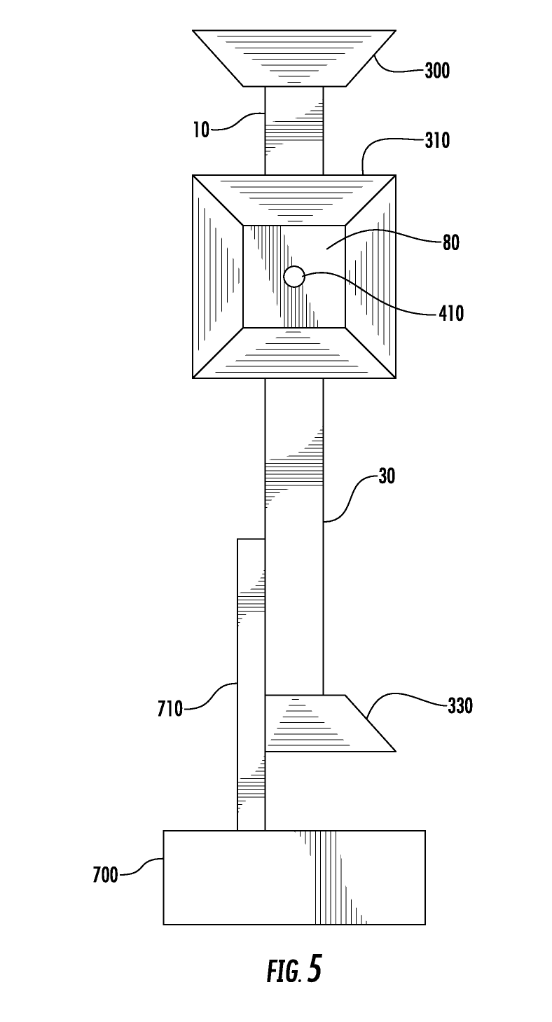

Reference is next made to FIG. 5, a left side view of the illuminated cross device in accordance with embodiments of the disclosure. Illustrated here is the left side 80 end portion light 410 which illuminates through the end cap component 310. Also shown is the base component 700, the attachment arm component 710, the upper half portion 10 of the hollow cruciform component, the lower half portion 30 of the hollow cruciform component, the top side end cap component 300, and the bottom side end cap component 330.

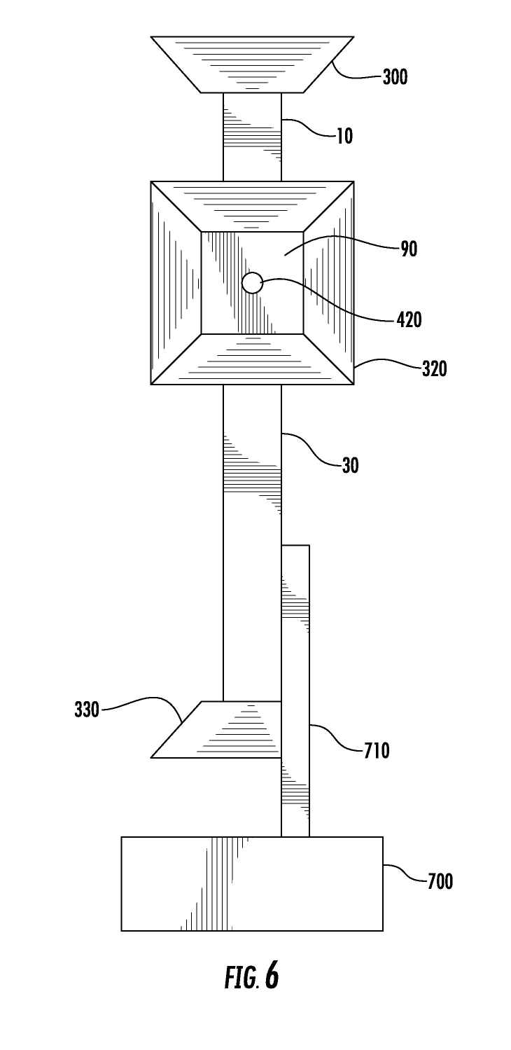

Reference is now made to FIG. 6, a right side view of the illuminated cross device in accordance with embodiments of the disclosure. Illustrated here is the right side 90 end portion light 420 which illuminates through the end cap component 320. Also shown is the base component 700, the attachment arm component 710, the upper half portion 10 of the hollow cruciform component, the lower half portion 30 of the hollow cruciform component, the top side end cap component 300, and the bottom side end cap component 330.

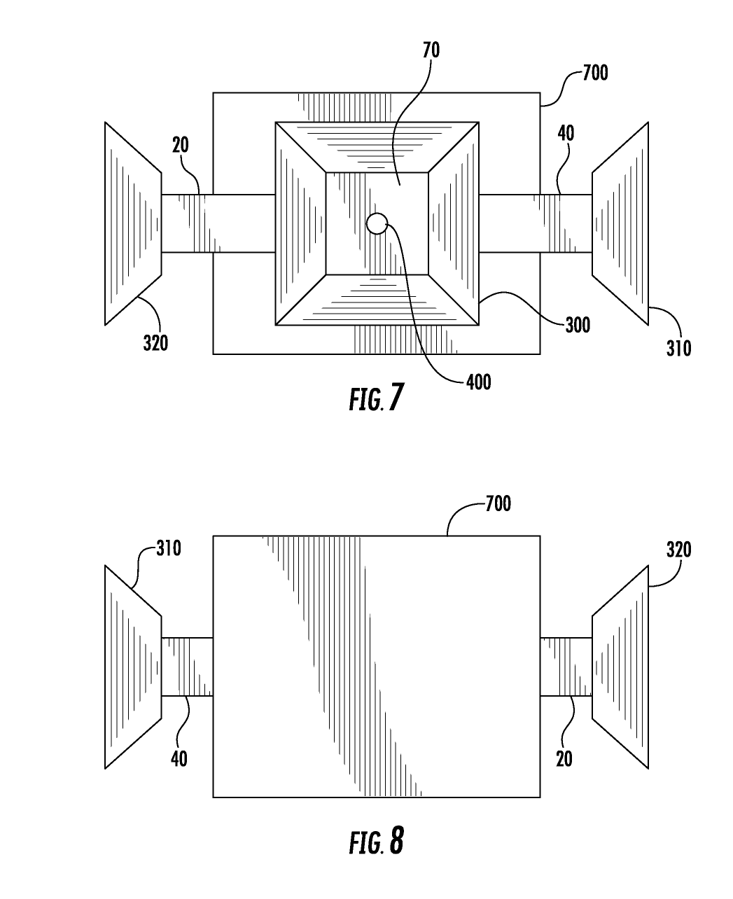

Reference is next made to FIG. 7, a top view of the illuminated cross device in accordance with embodiments of the disclosure. Illustrated here is the top side 70 end portion light 400 which illuminates through the end cap component 300. Also shown is the base component 700, the left side portion 40 of the hollow cruciform component, the right side portion 20 of the hollow cruciform component, the left side end cap component 310, and the right side end cap component 320.

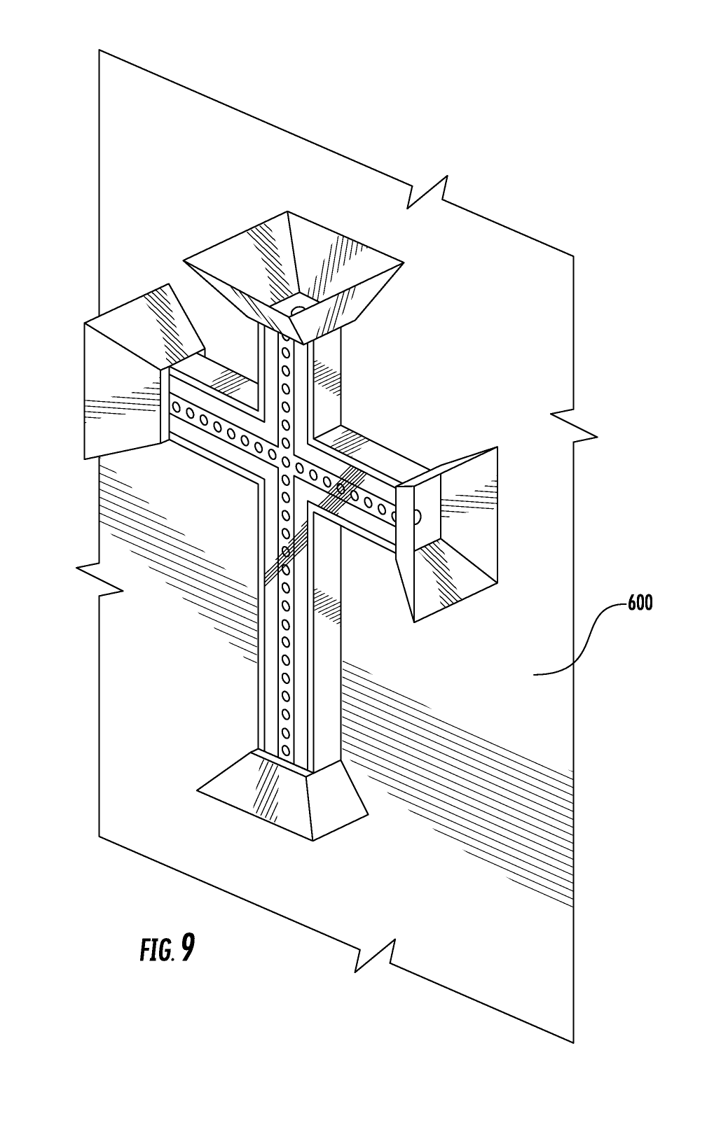

Reference is now made to FIG. 8, a bottom view of the illuminated cross device in accordance with embodiments of the disclosure. Here shown is the base component 700, the left side portion 40 of the hollow cruciform component, the right side portion 20 of the hollow cruciform component, the left side end cap component 310, and the right side end cap component 320 .

Reference is lastly made to FIG. 9, an environment view of the illuminated cross device mounted on a wall in accordance with embodiments of the disclosure. Illustrated here is the device mounted on a wall which may be achieved by the device being further comprised of hook or wall mounts on the back side of the illuminated cross device.

In brief, as described herein provides for devices and methods of use directed to illuminated crosses.

The disclosed devices and methods of use are generally described, with examples incorporated as particular embodiments of the invention and to demonstrate the practice and advantages thereof. It is understood that the examples are given by way of illustration and are not intended to limit the specification or the claims in any manner.

To facilitate the understanding of this invention, a number of terms may be defined below. Terms defined herein have meanings as commonly understood by a person of ordinary skill in the areas relevant to the present invention.

Terms such as “a”, “an”, and “the” are not intended to refer to only a singular entity, but include the general class of which a specific example may be used for illustration. The terminology herein is used to describe specific embodiments of the invention, but their usage does not delimit the disclosed systems or methods, except as may be outlined in the claims.

Any embodiments comprising a one piece or multi piece device having the structures and/or components as herein disclosed with similar function shall fall into the coverage of claims of the present invention and shall lack the novelty and inventive step criteria.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific devices and methods described herein. Such equivalents are considered to be within the scope of this invention and are covered by the claims.

All publications, references, patents, and patent applications mentioned in the specification are indicative of the level of those skilled in the art to which this invention pertains. All publications, references, patents, and patent application are herein incorporated by reference to the same extent as if each individual publication, reference, patent, or patent application was specifically and individually indicated to be incorporated by reference.

In the claims, all transitional phrases such as “comprising,” “including,” “carrying,” “having,” “containing,” “involving,” and the like are to be understood to be open-ended, i.e., to mean including but not limited to. Only the transitional phrases “consisting of” and “consisting essentially of,” respectively, shall be closed or semi-closed transitional phrases.

The devices and/or methods disclosed and claimed herein can be made and executed without undue experimentation in light of the present disclosure. While the devices and methods of this invention have been described in terms of preferred embodiments, it will be apparent to those skilled in the art that variations may be applied to the devices and/or methods and in the steps or in the sequence of steps of the method described herein without departing from the concept, spirit, and scope of the invention.

More specifically, it will be apparent that certain components, which are both shape and material related, may be substituted for the components described herein while the same or similar results would be achieved. All such similar substitutes and modifications apparent to those skilled in the art are deemed to be within the spirit, scope, and concept of the invention as defined by the appended claims.

What is claimed is:

1. An illuminated cross comprising:
a hollow cruciform housing component; and
a light source cruciform component;
wherein said light source cruciform component is position internal of said hollow cruciform housing component.

2. The illuminated cross of claim 1, wherein said hollow cruciform housing component is further comprised of upper portions, lower portions, a front side portion, and a back side portion.

3. The illuminated cross of claim 2, wherein said hollow cruciform component portions are all translucent.

4. The illuminated cross of claim 2, wherein said hollow cruciform component portions are a combination of translucent and non-translucent.

5. The illuminated cross of claim 2, wherein said front side and back side hollow cruciform component portions are translucent and said upper and lower side hollow cruciform component portions are non-translucent.

6. The illuminated cross of claim 2, wherein said hollow cruciform component portions are all transparent.

7. The illuminated cross of claim 2, wherein said hollow cruciform component portions are a combination of translucent and non-transparent.

8. The illuminated cross of claim 2, wherein said front side and back side hollow cruciform component portions are transparent and said upper and lower side hollow cruciform component portions are non-transparent.

9. The illuminated cross of claim 2, wherein said hollow cruciform component portions are a combination of translucent, transparent, and non-translucent non-transparent.

10. The illuminated cross of claim 1, wherein said light source cruciform component is further comprised of lights running along the front portion in the horizontal direction and in the vertical direction.

11. The illuminated cross of claim 1, wherein said light source cruciform component is further comprised of lights running less than the full length of the front portion in the horizontal direction and less than the full length of the front portion in the vertical direction.

12. The illuminated cross of claim 1, wherein said light source cruciform component is further comprised of lights running the full length of the front portion in the horizontal direction and the full length of the front portion in the vertical direction.

13. The illuminated cross of claim 10, wherein said light source cruciform component is further comprised of lights running along the back portion in the horizontal direction and in the vertical direction.

14. The illuminated cross of claim 10, wherein said light source cruciform component is further comprised of lights running less than the full length of the back portion in the horizontal direction and less than the full length of the back portion in the vertical direction.

15. The illuminated cross of claim 10, wherein said light source cruciform component is further comprised of lights running the full length of the back portion in the horizontal direction and the full length of the back portion in the vertical direction.

16. The illuminated cross of claim 1, wherein said light source cruciform component is further comprised of lights on the end portions.

17. The illuminated cross of claim 1, further comprising four end cap components positioned at the end portions of the cruciform.

18. The illuminated cross of claim 10, wherein said light source cruciform component is further comprised of lights running the full length of the back portion in the horizontal direction and the full length of the back portion in the vertical direction; and wherein said light source cruciform component is further comprised of lights on the end portions.

19. The illuminated cross of claim 18, further comprising four end cap components positioned at the end portions of the cruciform.

20. An illuminated cross comprising:
a hollow cruciform housing component; and
a light source cruciform component;
wherein said light source cruciform component is position internal of said hollow cruciform housing component;
wherein said hollow cruciform housing component is further comprised of upper portions, lower portions, a front side portion, and a back side portion;
wherein said light source cruciform component is further comprised of lights running the full length of the front portion in the horizontal direction and the full length of the front portion in the vertical direction;
wherein said light source cruciform component is further comprised of lights running the full length of the back portion in the horizontal direction and the full length of the back portion in the vertical direction;
wherein said light source cruciform component is further comprised of lights on the end portions; and
wherein said illuminated cross is further comprised of four end cap components positioned at the end portions of the cruciform.
